(19) United States
(12) Patent Application Publication
(10) Pub. No.: US 2025/0111439 A1
(43) Pub. Date: Apr. 3, 2025

(54) METHOD AND APPARATUS FOR PREDICTING INJURIES

(71) Applicant: Injsur.ai, Inc., Oak Park, CA (US)

(72) Inventors: Bret Polansky, Oak Park, CA (US); Kris Cadle, Oak Park, CA (US)

(73) Assignee: Injsur.ai, Inc., Oak Park, CA (US)

(21) Appl. No.: 18/886,931

(22) Filed: Sep. 16, 2024

Related U.S. Application Data
(60) Provisional application No. 63/542,234, filed on Oct. 3, 2023.

(51) Int. Cl. G06Q 40/08; G06N 20/00; G06Q 50/34

(52) U.S. Cl. CPC G06Q 40/08; G06N 20/00; G06Q 50/34

(57) ABSTRACT

The present system provides a method and apparatus for predicting a likelihood of injury of an individual. The system generates a frailty score that represents the likelihood of a person being injured. The frailty score is generated by using Artificial Intelligence (AI) and machine learning using a specialized data set. The frailty score can then trigger actions to reduce the possibility of injury or to determine whether to engage in the injury risking behavior at all.

This patent application claims priority to U.S. Provisional Patent Application 63/542,234 filed on Oct. 3, 2023, which is incorporated by reference herein in its entirety

### BACKGROUND OF THE SYSTEM

Workplace injuries pose significant risks and costs to both employees and employers. For employees, the immediate risk of a workplace injury is physical harm, which can range from minor cuts and bruises to severe injuries like fractures, burns, or even life-threatening conditions. Beyond the physical pain, these injuries can lead to long-term disabilities, mental health issues such as anxiety or depression, and a reduced quality of life. In some cases, workers may be unable to return to their previous jobs, leading to loss of income and career opportunities.

For employers, workplace injuries carry substantial financial costs. Direct costs include medical expenses, workers' compensation claims, and potential legal fees if the injury results in litigation. Indirect costs can be even more significant, including lost productivity, the cost of training replacement workers, and increased insurance premiums. Additionally, a workplace with a high rate of injuries may suffer from reduced employee morale and a damaged reputation, making it harder to attract and retain talent.

The broader economic impact of workplace injuries is also considerable. According to studies, workplace injuries and illnesses cost the economy billions of dollars annually in lost productivity and medical expenses. Employers, therefore, have a strong incentive to invest in safety measures, employee training, and robust health and safety policies to mitigate these risks and minimize costs. By doing so, they not only protect their employees but also safeguard their business operations and financial stability.

There is some wide demographic data about when injuries are more prevalent. Studies have shown that July and August tend to have a greater number of workplace injuries than in other months. In addition, it appears that Mondays have a greater number of injuries than any other day, and that more workplace injuries occur between 10 a.m. and 2 p.m.

This data is general and every industry has its own risks and likelihood of injury. There would be an advantage if it was possible to know a risk of injury for an individual worker so that appropriate risk prevention could be undertaken.

One area of workplace injuries of particular interest are in sports. Many people play Fantasy sports and can be impacted by the health of the players. Fantasy sports have emerged as a dynamic and immersive form of sports entertainment that has captured the imagination of millions of enthusiasts worldwide. Rooted in the passion for real-world sports, fantasy sports provide participants with an opportunity to become team managers, make strategic decisions, and engage in friendly competition with others.

The roots of fantasy sports can be traced back to the 1960s and 1970s when a few sports enthusiasts began devising rudimentary systems for simulating baseball and football seasons. These early endeavors laid the groundwork for what would later become a global phenomenon. However, the true birth of fantasy sports is often attributed to Daniel Okrent, a journalist and author, who created the first known fantasy baseball league in 1980, famously called the “Rotisserie League.” The concept quickly gained popularity among his peers and began to spread.

The heart of fantasy sports lies in selecting and assembling a virtual team of real-world athletes from a particular sport, such as football, basketball, baseball, soccer, and more. Participants act as team managers and choose their players through a draft, auction, or other selection processes.

Points are awarded to fantasy teams based on the performance of their selected athletes in real-world games. Scoring systems vary from sport to sport but typically include statistics like points scored, assists, rebounds, touchdowns, total yards, receptions, completions, strikeouts, hits, home runs, goals, defensive actions, and many more.

Fantasy sports are typically played within leagues, which can be private, public, or organized by websites and platforms dedicated to fantasy sports. Leagues establish the rules, draft order, and scoring settings, and participants compete against each other over a designated season. Fantasy team managers must make strategic decisions throughout the season, such as starting lineups, making trades, and picking up free agents. These decisions directly impact a team's success.

The advent of the internet in the late 20th century revolutionized fantasy sports. Online platforms and apps emerged, offering user-friendly interfaces, real-time statistics, and an interactive community for participants. Popular platforms like ESPN Fantasy Sports, Yahoo Fantasy Sports, and DraftKings have attracted millions of users.

The growth of fantasy sports has been staggering. It has expanded beyond traditional sports like baseball and football to encompass a wide range of sports and even esports. Additionally, fantasy sports have transcended borders, with players from around the world joining leagues and competing against each other.

Fantasy sports have deepened fans' engagement with real-world sports by giving them a personal stake in the outcomes of games. It has also introduced new audiences to sports they might not have otherwise followed. The fantasy sports industry has become a multi-billion-dollar enterprise, with revenue generated through entry fees, advertising, sponsorships, and partnerships. It has created employment opportunities, including analysts, content creators, and app developers.

There are two principal kinds of fantasy sports, season long fantasy sports (SLS) and daily fantasy sports (DFS) which differ in several ways.

### Duration:

DFS: Daily Fantasy Sports games typically last for a single day or a specific set of games within a day. Participants draft a new lineup for each contest they enter, and the results are determined by the performance of the players in those specific games. In football, DFS may a specific set of games, or single games of each week's schedule.

SLS: Season-Long Fantasy Sports games span an entire sports season, such as an entire NFL football season or an NBA basketball season. Participants draft a team at the beginning of the season and make adjustments throughout the year, including trades and waiver wire acquisitions.

### Roster Management:

DFS: In DFS, you select a new lineup for each contest. There are no long-term commitments to players, and you have the flexibility to choose different players every day or week.

SLS: In SLS, you draft a team at the beginning of the season, and your roster remains relatively stable throughout the year. You may make occasional changes through trades or free-agent pickups, but the core of your team stays intact. In SLS, each team has a certain number of players that can be selected each week to be “active” for scoring purposes. However, typically an SLS team will have a bench of additional players that can be activated or not depending on strategy and circumstances.

### Scoring:

DFS: DFS contests have various scoring systems, but they usually reward individual player performance in a specific game or set of games. Scoring can vary by platform and sport but often includes points scored, assists, rebounds, touchdowns, total yards, receptions, completions, strikeouts, hits, home runs, goals, defensive actions, and many more

SLS: SLS leagues also have scoring systems, but they are usually more focused on team performance and player consistency over the entire season. Points are accumulated throughout the season based on player statistics, and the cumulative total determines the winner.

### Prizes:

DFS: DFS contests often have cash prizes and may offer daily or weekly payouts, depending on the platform and the specific contest. Participants can win money in a short timeframe.

SLS: SLS leagues often involve a buy-in fee, and the prizes are distributed at the end of the season. Prizes in season-long leagues may include cash, trophies, or bragging rights.

### Strategy:

DFS: DFS requires a focus on short-term player performance and matchup analysis. You need to adapt to changing circumstances and player injuries on a daily or weekly basis.

SLS: SLS involves a longer-term strategy. You need to consider factors like player consistency, injury risk, and season-long trends when drafting and managing your team.

### Community and Engagement:

DFS: DFS can be more solitary, as you are competing against others in daily or weekly contests. It may have less emphasis on the social aspect of fantasy sports.

SLS: SLS often involves a more extensive social aspect, with a group of friends or colleagues competing in a season-long league. The sense of community and rivalry can be a significant part of the experience.

In summary, Daily Fantasy Sports is a shorter-term, more dynamic format with daily or weekly contests and flexible roster management, while Season-Long Fantasy Sports involves a season-long commitment, stability in rosters, and a focus on overall season performance. Both formats offer unique challenges and enjoyment for fantasy sports enthusiasts.

Fantasy sports are inherently skill based, in assembling a roster, analyzing matchups, and determining a best strategy. However, as with many things, there is an element of luck involved. In fantasy sports, luck is often tied to player injuries.

A problem arises when a player is injured. If a player is injured in a DFS league, particularly a star player, then the team owner has significantly reduced chances of winning. Even if the player is not a star, losing any player reduces the possibility of a payout because the team owner is sacrificing points by having fewer players to score than others.

Many SLS fantasy leagues have a meaningful entry fee (even in the thousands) and a large amount of prize money to the winning team. Unfortunately, if a star player becomes injured, especially in the early part of the season, or right before the fantasy playoffs begin, that team owner has had their chances to win the league (and prize money) severely diminished. The chance is further diminished if the injury is season ending or more than four games.

This is not a small issue because injuries are quite common in sports, especially in fantasy football. A recent example is star quarterback Aaron Rodgers being injured 4 plays into the season. Many fantasy team owners who selected (and paid highly for) Aaron Rodgers are now competing with a depleted team.

### SUMMARY

The present system provides a method and apparatus for predicting a likelihood of injury of an individual. The system generates a frailty score that represents the likelihood of a person being injured. The frailty score is generated by using Artificial Intelligence (AI) and machine learning using a specialized data set. The frailty score can then trigger actions to reduce the possibility of injury or to determine whether to engage in the injury risking behavior at all.

The system collects data related to employee health, job performance, and financial records. This data is preprocessed to ensure accuracy and relevance. Such data can include factors such as age, job role, work environment, historical injury data, and the like. The system contemplates continuous updating of the system with new data to increase accuracy and prediction reliability. Current environmental information can be provided (e.g. weather, time of day, day of week, hours worked, work crew members, and the like) to increase accuracy. The system provides actionable insights to HR (Human Resource) managers, enabling them to implement preventive measures and optimize workforce management. Recommendations may include ergonomic adjustments, training programs, or changes in work assignments. This system is applicable across various professions where injury significantly affects financial remuneration, including but not limited to: Construction Workers, Healthcare Professionals, Firefighters, Police Officers, Agricultural Workers, Delivery Drivers, Manufacturing Workers, Electricians, Plumbers, Roofers, Miners, Pilots, Flight Attendants, Fishermen, Loggers, Maintenance Workers, Truck Drivers, Welders, Carpenters, Ironworkers or any industry or profession where injuries can impact the worker and/or workplace.

In addition, the present system provides the ability of a fantasy sports owner to purchase insurance on a player by player basis, on a seasonal basis, or even on a game by game basis, so that if a player gets injured, and the owner has purchased the insurance, the owner will receive some compensation for the injured player. If the player does not get injured, the premium is kept by the system. In addition, the system provides an artificial intelligence (AI) based engine to generate a frailty score for each player, allowing an owner to make the most informed decisions on use of insurance and team selection.

### BRIEF DESCRIPTION OF THE DRAWINGS

FIG. 1 is a flow diagram of purchasing insurance in an embodiment of the system.

FIG. 2 is a block diagram of an embodiment of the system.

FIG. 3 is a flow diagram of a user interface in an embodiment of the system.

FIG. 4 is a block diagram of the AI Model Training in an embodiment.

FIG. 5 is a functional description of the system in an embodiment.

FIG. 6 is a flow diagram illustrating a machine learning model in an embodiment of the system.

FIG. 7 is a flow diagram illustrating recursive optimization in an embodiment of the system.

### DETAILED DESCRIPTION OF THE SYSTEM

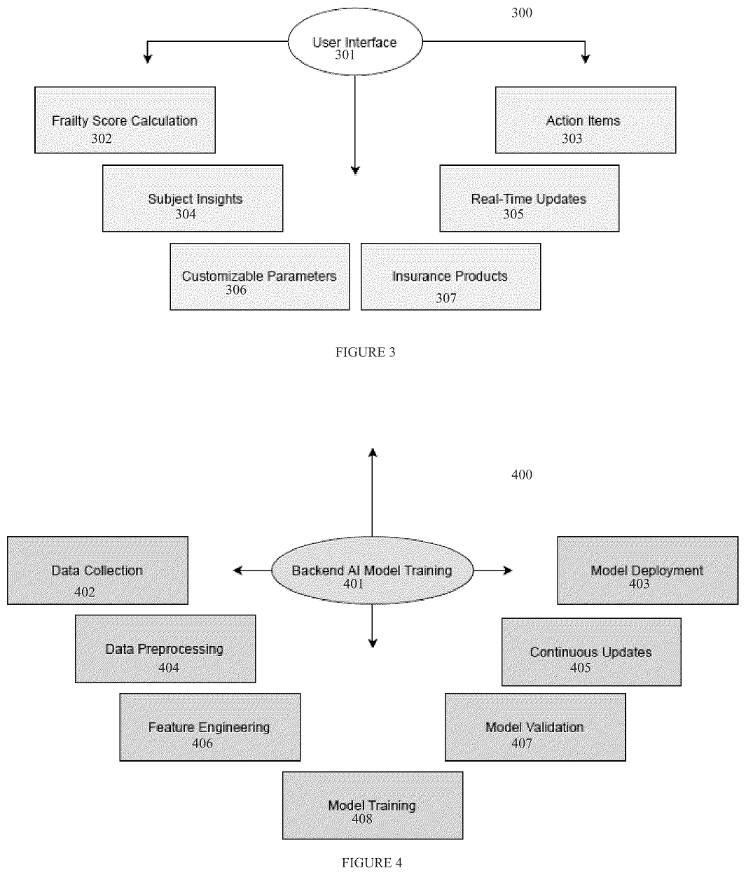

The system generates a frailty score for an individual that represents a chance of injury of that individual in a certain time period. The frailty score may be for an individual, a type of worker or employee in a general sense (e.g. frailty score for drivers, mechanics, etc.), company based scores, an even industry based scores. A flow diagram illustrating the operation of the system in an embodiment is illustrated in FIG. 3.

The system 300 includes a user interface 301 The system presents a Frailty Score Calculation 302 for an individual along with Subject Insights 304 about that individual. Subject Insights 304 can represent characteristics about the individual that might be material to the calculation of the Frailty Score 302 and could aid in other decision making processes using the system. For example, the injury history of that particular worker could be an insight that will help refine the frailty score. In addition, environmental factors such as time of day (day vs. night) temperature (hot or cold); weather (rainy, stormy, hail, snow, windy), location of the task the worker is performing, age of the worker, number of hours previously worked in advance of the task, and the like. There is an interface for Customizable Parameters 306 that allow for specific metrics to be defined and/or weighted for each individual.

Action Items 303 presents actions that could be taken to reduce the frailty score of the individual or to remediate potential injuries based on the frailty score. The system includes Real Time Updates 305 that could impact the frailty score in either direction (e.g. weather, tasks, presence or absence of other individuals, and the like). In one embodiment, the system offers Insurance Products 307 that can be used to provide compensation if an injury does occur.

The system uses AI and Machine Learning to generate a frailty score for an individual. The system uses historical, present, and updated data to build a data set on which the AI can be trained.

FIG. 4 is a block diagram of the AI Model Training in an embodiment. The system 400 implements Backend AI Model Training 401. Data Collection module 402 acquires the data sets to be used in training the AI. Data Preprocessing 404 analyzes the data, normalizes it as necessary, adds meta-data as appropriate and creates and updates different versions of data sets for use by the AI.

Feature Engineering Module 406 implements a process of creating new input features or transforming existing ones to enhance the model's ability to learn patterns and make accurate predictions. Model Training module 408 implements one or more AI training approaches as described below to train the AI to generate a frailty score. The system receives continuous updates 405 of data for individuals, environmental data, and other data used to generate a frailty score. Model Validation 407 implements one or more AI training validation techniques to fine tune the AI model for eventual deployment at Deployment Module 403.

In one embodiment, the system builds a Data Collection 402 that includes injury data, injury history, environmental data, temporal data, task data; presence or absence of other individuals, and other metrics and data used to generate a frailty score.

### Model Selection

The system can use one or more of several training models. The system can use Linear Models, Tree-based models, Neural Networks, and/or other models including Support Vector Machines, K-nearest neighbors, Naïve Bayes, Gaussian Process Regression, Extreme Learning Machines, Stochastic Gradient Descent, Bayesian Networks, and the like.

The Deep Neural Network (DNN) is a type of artificial neural network with multiple layers between the input and output layers. These intermediate layers, often called hidden layers, enable the network to model complex relationships in data. Each layer consists of numerous interconnected neurons, or nodes, that process information through weighted connections. The network learns by adjusting these weights during training, typically using a process called backpropagation, which minimizes the error between the network's predictions and actual outcomes. DNNs are particularly powerful for tasks involving large datasets and high-dimensional data, such as image and speech recognition, natural language processing, and autonomous driving, due to their ability to capture intricate patterns and representations in the data. In one embodiment, the input layer processes the data set described above. The hidden layers provide a hierarchical representation of the complex relationships between data points and the output layer, in one embodiment, uses a sigmoid activation function for injury probability estimation.

A Deep Neural Network (DNN) is a type of artificial neural network with multiple layers between the input and output layers. These intermediate layers, often called hidden layers, enable the network to model complex relationships in data. Each layer consists of numerous interconnected neurons, or nodes, that process information through weighted connections. The network learns by adjusting these weights during training, typically using a process called backpropagation, which minimizes the error between the network's predictions and actual outcomes. DNNs are particularly powerful for tasks involving large datasets and high-dimensional data, such as image and speech recognition, natural language processing, and autonomous driving, due to their ability to capture intricate patterns and representations in the data.

Hyperplane and Margin: In a binary classification problem, an SVM aims to find a hyperplane that separates the data points of the two classes. The best hyperplane is the one that maximizes the margin, which is the distance between the hyperplane and the nearest data points from each class, known as support vectors.

Support Vectors: These are the critical data points that lie closest to the decision boundary (hyperplane). They aid in defining the position and orientation of the hyperplane. The algorithm focuses on these support vectors to find the optimal hyperplane.

Kernel Trick: SVMs can handle non-linearly separable data by transforming it into a higher-dimensional space using kernel functions. Common kernels include linear, polynomial, radial basis function (RBF), and sigmoid. This transformation allows the SVM to find a hyperplane in the new space that can separate the classes more effectively.

Objective Function: The SVM algorithm seeks to minimize the classification error while maximizing the margin. This is achieved by solving a convex optimization problem, ensuring a global optimum solution.

Soft Margin: In cases where the data is not perfectly separable, SVMs introduce a soft margin that allows some misclassification but penalizes it. This is controlled by a regularization parameter (C), which balances the trade-off between maximizing the margin and minimizing the classification error.

SVMs are known for their robustness and effectiveness, particularly in high-dimensional spaces. They are used in various applications, such as image and text classification, bioinformatics, and finance, due to their ability to handle complex and high-dimensional datasets while providing high accuracy and generalization capabilities.

In one embodiment, the LLM is used for user interface integration, allowing it to facility user interaction through natural language processing (NLP). The LLM also enhances data comprehension and model insights.

Comparative Model Analysis is a systematic approach used in machine learning and statistics to evaluate and compare the performance of different models on a given task. The goal is to determine which model is most suitable for a specific problem based on various criteria, such as accuracy, efficiency, and robustness.

Model Selection: The first step involves selecting the models to be compared. These models can vary in complexity, underlying algorithms, and assumptions. Common choices include linear regression, decision trees, random forests, support vector machines, neural networks, and ensemble methods.

Bagging (Bootstrap Aggregating) involves training multiple models independently on different random subsets of the training data and then aggregating their predictions, often by averaging or voting. Random forests, which aggregate multiple decision trees, are a popular example of bagging.

Boosting focuses on training a sequence of models, each one correcting the errors of its predecessor. Models are trained in series, with more weight given to misclassified instances in subsequent iterations. Gradient boosting machines (GBMs) and AdaBoost are well-known boosting techniques.

Gradient Boosting Machines (GBMs) are a powerful and widely-used ensemble learning technique for both regression and classification tasks. The goal of GBMs is to build a strong predictive model by combining the outputs of several weak models, typically decision trees, in a sequential manner.

Sequential Learning: GBMs build models in a sequence, where each new model aims to correct the errors made by the previous models. This iterative approach focuses on improving the performance of the ensemble by learning from the mistakes of the earlier models.

Weak Learners: The individual models used in GBMs are often simple decision trees, known as weak learners. These trees are typically shallow (having limited depth) to ensure that they do not overfit the data. Each tree is trained to correct the residual errors of the combined ensemble of all previous trees.

Gradient Descent Optimization: The “gradient” in Gradient Boosting refers to the optimization technique used to minimize the loss function. At each iteration, the algorithm calculates the gradient of the loss function with respect to the model's predictions and fits a new tree to this gradient. Essentially, each new tree is constructed to point in the direction that reduces the overall error the most.

Additive Model: The final model in a GBM is an additive combination of all the weak learners. The predictions of each tree are weighted and summed to produce the final output. The contribution of each tree is scaled by a learning rate parameter, which controls how much each new tree influences the overall model.

Regularization: To prevent overfitting, GBMs incorporate various regularization techniques, such as limiting the depth of the trees, using shrinkage (learning rate), and subsampling the data. Regularization helps in making the model more robust and improves its generalization to unseen data.

Loss Functions: GBMs can be applied to different types of problems by choosing appropriate loss functions. For regression, common loss functions include mean squared error (MSE) and mean absolute error (MAE). For classification, loss functions like log-loss or exponential loss are used.

GBMs are known for their high accuracy and flexibility, making them suitable for a wide range of applications, including finance, marketing, and healthcare. They are particularly effective in handling complex datasets with many features and interactions. Popular implementations of Gradient Boosting Machines include XGBoost, LightGBM, and CatBoost, which offer efficient and scalable solutions for large-scale machine learning tasks.

Stacking involves training multiple models (often called base learners) and then using another model (meta-learner) to combine their predictions. The meta-learner typically takes the outputs of the base learners as input features to make the final prediction.

The Ensemble learning may also implement Support Vector Machines (SVMs) to classify injury risk categories. SVMs are a powerful set of supervised learning algorithms used for classification and regression tasks. The goal is to find the optimal hyperplane that best separates the data points of different classes in a high-dimensional space.

### Model Training

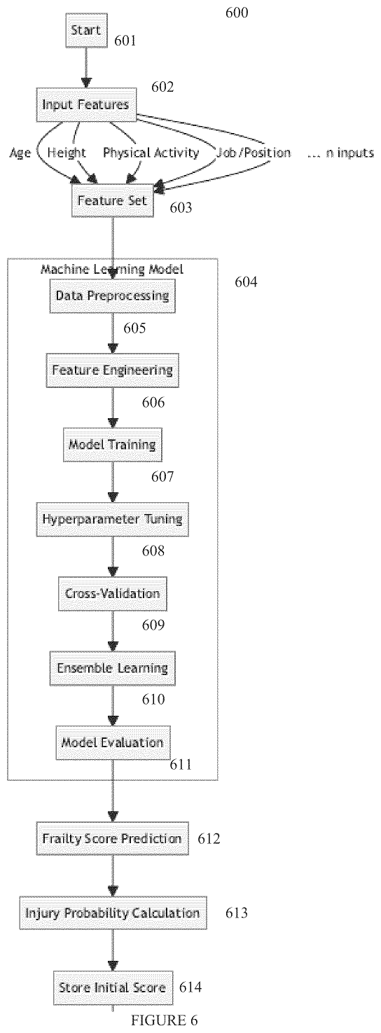

FIG. 6 is a flow diagram 600 of the training of the machine learning model in an embodiment. At step 601 the system starts. At step 602 the system receives input features to generate a feature set 603.

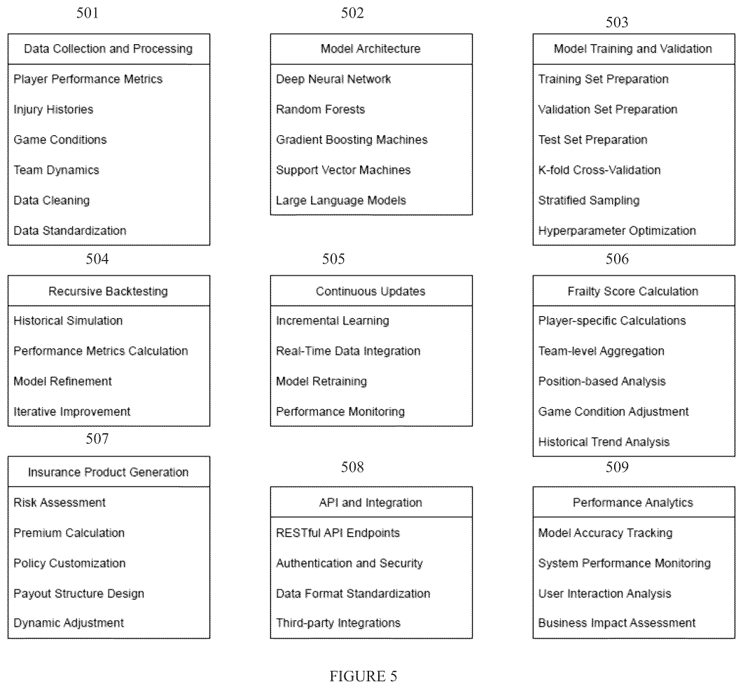

In one embodiment, the input features 602 comprises injury data as shown at 501 in FIG. 5 and can be described as follows.

### Injury History

Injury Types:
Sprains: Ligament injuries caused by overextension.
Strains: Muscle or tendon injuries due to overstretching.
Fractures: Bone breaks or cracks resulting from trauma.
Concussions: Brain injuries caused by impact or sudden movement.
Ligament Tears: Rupture or tearing of ligaments supporting joints.
Muscle Tears: Damage to muscle tissue from overexertion.
Contusions: Deep tissue bruises resulting from direct impact.
ACL Tear: Anterior Cruciate Ligament tear, often requiring surgery.
MCL Tear: Medial Collateral Ligament tear, affecting the knee's stability.
Meniscus Tear: Torn cartilage in the knee joint, often causing pain and swelling.
Shoulder Dislocation: Shoulder joint forced out of its socket, requiring relocation.
Rotator Cuff Injury: Tears or strains in the muscles and tendons of the shoulder.
Hamstring Strain: Injury to the muscles at the back of the thigh.
Ankle Sprain: Stretch or tear of ligaments around the ankle joint.
Hip Flexor Strain: Injury to the group of muscles that enable bending at the hip.
Rib Fracture: Cracks or breaks in the rib bones, often from impact.
Spinal Cord Injury: Damage to the spinal cord resulting in loss of function or sensation.
PCL Tear: Posterior Cruciate Ligament tear, affecting stability in the knee joint.
Patellar Tendonitis: Inflammation or injury to the tendon connecting the kneecap to the shinbone.
Achilles Tendon Rupture: Tear of the Achilles tendon, often requiring surgical repair.
Facial Fractures: Fractures of bones in the face due to impact.
Hand and Finger Injuries: Including fractures, dislocations, and tendon injuries.
Neck Sprain or Strain: Injury to muscles, ligaments, or tendons in the neck region.
Foot Injuries: Including metatarsal fractures, plantar fasciitis, and turf toe.
Heat Exhaustion or Heat Stroke: Serious heat-related conditions during intense physical activity.
Heat Cramps: Painful muscle contractions due to dehydration and electrolyte imbalance.
Heat Syncope: Fainting or dizziness due to heat exposure during physical exertion.
Heat Rash: Skin irritation or rash due to heat and sweating.
Hyponatremia: Low sodium levels in the blood, potentially caused by excessive fluid intake during activity.
Overuse Injuries: Including tendonitis, stress fractures, and chronic muscle strains from repetitive movements.

### Injury Details

Head:
Concussions, contusions, fractures
Symptoms: Headaches, dizziness, cognitive impairment
Neck:
Sprains, strains, fractures, stingers
Symptoms: Pain, limited mobility, numbness
Shoulder:
Dislocations, separations, rotator cuff tears, labral tears
Symptoms: Pain, instability, reduced range of motion
Arm:
Fractures, muscle strains, nerve injuries
Symptoms: Pain, weakness, tingling
Elbow:
Dislocations, fractures, tendonitis, bursitis
Symptoms: Pain, swelling, limited mobility
Wrist:
Fractures, sprains, carpal tunnel syndrome
Symptoms: Pain, swelling, numbness
Back:
Muscle strains, disc herniations, spinal fractures
Symptoms: Pain, stiffness, radiating pain
Hip:
Labral tears, hip pointers, dislocations, muscle strains
Symptoms: Pain, reduced mobility, weakness
Thigh:
Hamstring strains, quadriceps strains, contusions
Symptoms: Pain, swelling, limited strength
Knee:
ACL tears, MCL tears, meniscus tears, patellar tendonitis
Symptoms: Pain, instability, swelling
Ankle:
Sprains, fractures, Achilles tendon injuries
Symptoms: Pain, swelling, limited mobility
Foot:
Fractures, plantar fasciitis, turf toe
Symptoms: Pain, swelling, difficulty walking
Severity Levels
Minor:
Symptoms: Mild pain, slight swelling, minor bruises
Impact: Minimal impact on performance and short recovery time
Moderate:
Symptoms: Noticeable pain, moderate swelling, reduced function
Impact: Significant impact on performance, requires treatment and longer recovery
Severe:
Symptoms: Intense pain, significant swelling, major loss of function
Impact: Major impact on performance, may require surgery and extensive recovery

### Recovery Time

Days:
Minor injuries like mild strains, minor bruises, and slight sprains
Weeks:
Moderate injuries such as moderate sprains, strains, and minor fractures
Months:
Severe injuries like major fractures, ligament tears, and serious muscle injuries

### Risk of Re-injury

Low:
Injuries with a quick recovery and minimal impact on future performance, often with proper rehabilitation (e.g., minor muscle strains).
Moderate:
Injuries that have a significant recovery period but can heal completely with the right treatment and care, with some risk of recurrence (e.g., moderate sprains, partial ligament tears).
High:
Injuries that have a high chance of recurrence even after full recovery due to the nature of the injury or the sport's demands (e.g., severe ligament tears, recurring concussions, chronic back issues).
Injury history of each worker. The prior injuries of a worker, along with all relevant meta data associated with that injury, are include in the data set.

FIG. 5 is a functional diagram of the system implementation in an embodiment, including Data collection and processing 501, Model Architecture 502, Model Training and Validation 503, Recursive Backtesting 504, Continuous Updates 505, Frailty Score Calculation 506, Insurance Product Generation 507, API and integration 508, and Performance Analysis 509.

### Machine Learning Model

The machine learning model 604 uses the historical data and feature set to generate a frailty score. At step 605 the system performs data pre-processing to normalize the data. Data preprocessing in a machine learning model involves preparing raw data to make it suitable for building a machine learning model. Raw data often contains noise, missing values, or irrelevant information that can affect the performance of the model. Preprocessing transforms this data into a cleaner format to improve model accuracy and efficiency, including normalization, noise removal, encoding, and the like.

At step 606 the system implements feature engineering. Feature engineering in a machine learning model is the process of creating new input features or transforming existing ones to enhance the model's ability to learn patterns and make accurate predictions. The goal of feature engineering is to improve the performance of machine learning algorithms by providing them with more meaningful, relevant, or informative data. This can be generating new polynomial features, domain knowledge features, and the like.

At step 607 engineered features are used to train predictive models capable of assessing frailty scores. In one embodiment, the machine learning architecture 502 uses a plurality of learning techniques to generate the frailty score, including a Deep Neural Network, Random Forests, Gradient Boosting Machines, Support Vector Machines Ensemble Learning, Large-Language Models (LLMs); and the like.

At step 610 the system implements Ensemble Learning. Ensemble learning is a machine learning technique that combines the predictions of multiple models to improve overall performance and robustness. The idea is to leverage the strengths of various models to achieve better predictive accuracy and generalization compared to any single model. There are several methods of ensemble learning, including bagging, boosting, and stacking.

At step 611 the system performs model evaluation. Evaluation Metrics: Common evaluation metrics used to compare the models include accuracy, precision, recall, F1-score, mean squared error (MSE), mean absolute error (MAE), and area under the ROC curve (AUC). The choice of metrics depends on the nature of the problem (classification, regression, etc.) and the specific goals of the analysis.

Statistical Testing: To determine if the performance differences between models are statistically significant, various statistical tests can be employed. Common tests include paired t-tests, Wilcoxon signed-rank tests, and ANOVA. These tests help in assessing whether observed performance differences are likely due to random chance or represent genuine differences in model effectiveness.

Model Complexity and Interpretability: Beyond performance metrics, factors such as model complexity and interpretability are also considered. Simpler models are often preferred for their ease of interpretation and lower risk of overfitting, while more complex models might be chosen for their superior predictive power despite being less interpretable.

Resource Efficiency: The computational cost of training and deploying the models is another crucial aspect of comparative model analysis. Models that require extensive computational resources or time might be less practical in certain applications, even if they offer slightly better performance.

At step 612 the system outputs a frailty score prediction, which is used at step 613 to generate an injury probability calculation, which is then stored as the initial frailty score at step 614.

At step 608 the system does Hyperparameter tuning. Hyperparameter tuning in machine learning is the process of optimizing the parameters of a model that are not learned from the training data but are set before the training process begins. These parameters, known as hyperparameters, control the behavior of the learning algorithm and can significantly influence the model's performance.

Examples of hyperparameters include: Learning rate (for gradient-based algorithms like neural networks or gradient boosting), Number of trees in a random forest Depth of a tree in decision trees or boosted trees, Number of hidden layers and units in neural networks, Regularization parameters (like L1, L2 penalties in regression or dropout rate in neural networks), Batch size and number of epochs in deep learning.

At step 609 the system performs Cross-validation to ensure its robustness and generalizability across different data sets. To ensure the comparison is fair and the results are generalizable, cross-validation techniques are often used. K-fold cross-validation is a popular method where the data is split into K subsets, and each model is trained and evaluated K times, with each subset serving as the validation set once. This helps in mitigating the effects of overfitting and provides a more reliable estimate of model performance.

### Recursive Optimization 700

Recursive backtesting 504 includes Historical Simulation, Performance Metrics Calculation, Model Refinement, and Iterative improvement in an embodiment. Recursive backtesting is a technique used in financial modeling and algorithmic trading to evaluate the performance of a trading strategy over historical data while simulating the process of learning and adjusting the model over time. It involves continuously updating the model as new data becomes available, thereby mimicking the real-world scenario where a model is periodically retrained and adjusted. In the present system, the Recursive Backtesting is used to evaluate the frailty score.

Sequential Updating: After the initial training, the model is tested on a small out-of-sample testing set to evaluate its performance. The next step involves expanding the training set by including the most recent data points from the testing set, retraining the model on this new, larger training set, and then testing it on the next set of out-of-sample data. This process is repeated sequentially over the entire historical dataset.

Rolling Window Approach: A common variation of recursive backtesting is the rolling window approach. In this method, a fixed-size window of data is used for training the model, and as new data becomes available, the oldest data points in the window are replaced by the most recent ones. This approach ensures that the model is always trained on the most recent data, which can be crucial for adapting to changing market conditions.

Transaction Costs and Slippage: Recursive backtesting should account for transaction costs and slippage to provide a more realistic evaluation of the strategy. These costs can significantly impact the profitability of a strategy and must be included in the backtesting framework.

Real-World Simulation: Recursive backtesting closely mimics the real-world scenario of deploying a strategy. In reality, models are periodically retrained with the latest data, and their parameters are adjusted based on recent performance. Recursive backtesting captures this dynamic aspect, providing a more accurate assessment of how the strategy would perform in the real world.

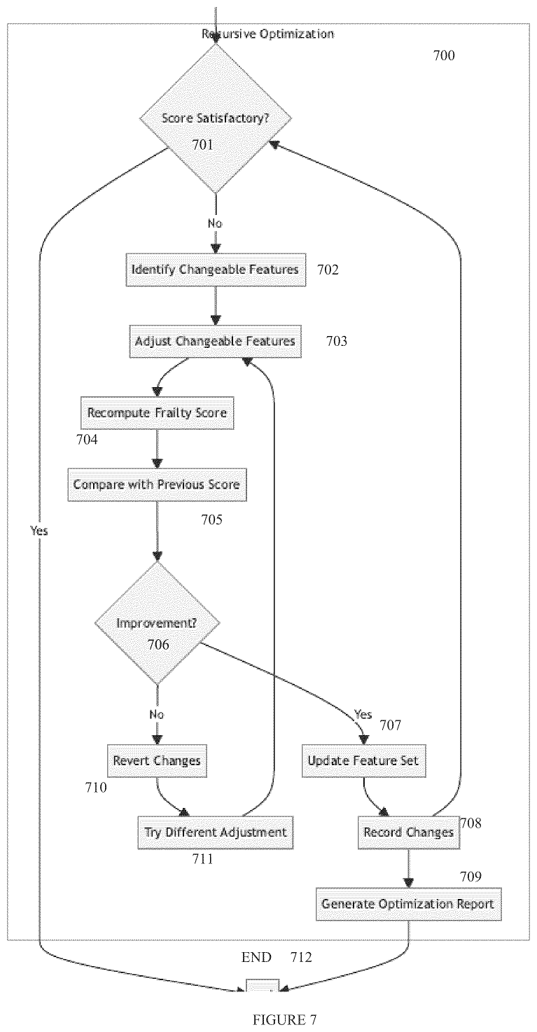

After the model is trained as shown in FIG. 6, the system applies recursive optimization as shown in the flow diagram 700 of FIG. 7. At decision block 701 it is determined if the frailty score for a person is satisfactory. If yes, the system Ends at step 712. If the score is not satisfactory, the system proceeds to step 702 to identify changeable features. For an individual, the changeable features might be the injury history for that individual, environmental conditions (weather, temperature, daylight/night, wind, and the like0.

At step 703 the identified changeable features are adjusted by the AI. At step 704 the frailty score is recomputed using the changed features and compared to the previous frailty score (that was considered unsatisfactory at step 701) at step 705. At decision block 706 it is determined if the recalculated frailty score is an improvement over the prior frailty score. If not, the system reverts the changes to the changeable features at step 710 and tries a different adjustment at step 711 and returns to step 703.

If the newly calculated frailty score is an improvement at step 706, the system proceeds to step 707 and adjusts the feature set, recording the changes at step 708. From there the system returns to step 701 for more recursion, and also generates an optimization report at step 709 before ending at step 712.

The Model Training and Evaluation 503 in one embodiment includes Training Set Preparation, Validation Set Preparation, Test Set Preparation, K-fold cross-validation, Stratified Sampling, and Hyperparameter optimization.

Domain-Specific Considerations: Finally, domain-specific factors and constraints must be taken into account.

### Continuous Updates

The system provides Continuous Updates 505, including incremental learning, real-time data integration, model retraining, and performance monitoring. Overfitting Prevention: By continuously updating the model with new data and testing it on out-of-sample sets, recursive backtesting helps in identifying and mitigating overfitting. This process ensures that the model is not just tailored to historical data but is robust enough to perform well on unseen data.

Performance Analysis: Once the models have been evaluated using the selected metrics and cross-validation, their performance is analyzed. This involves comparing the average metrics across folds and assessing the variability in performance. Visual tools like box plots, ROC curves, and confusion matrices can help in understanding the differences between models.

Performance Evaluation: At each step of the recursive backtesting process, the model's performance is recorded. Key performance metrics such as return, risk-adjusted return (e.g., Sharpe ratio), drawdown, and hit rate are calculated to evaluate the strategy's effectiveness over time.

### Data Collection and Processing

In one embodiment, the system uses proprietary data sets 501 including a Training Set, a Validation Set, and a Test Set of data. The Training Set is a comprehensive data set that has been compiled using published, self-reported, and inferred historic injury data and a complex mix of specific worker statistics.

The Validation Set is a tuning model to prevent overfitting. The validation set in machine learning is a subset of the data used to tune the model's hyperparameters and assess its performance during training. It is distinct from the training set, which is used to fit the model, and the test set, which is used for final evaluation after the model is fully trained. The Validation Set is used to find the best values for hyperparameters, which are parameters set before the learning process begins (e.g., learning rate, number of layers in a neural network). The Validation Set is updated with the new data (including conditions and other metrics noted above) to increase the system accuracy.

The Test Set applies backtesting to the team rosters to calculate updated frailty scores for individuals who have not been injured. The Test Set is a data set that is independent of the training data set, but that follows the same probability distribution as the training data set. The Test Set is a known set of data with a known result that acts as a “control” for the machine learning process. The Test Set can help detect overfitting of the model.

The system in one embodiment uses K-Fold Cross-Validation to check the model. K-fold cross-validation is a technique used in machine learning to assess the performance of a model. It involves partitioning the dataset into k equal-sized subsets, or “folds.” For each iteration (total k iterations), one of the folds is held out as the validation set, and the remaining k-1k-1k-1 folds are used to train the model. The model is trained on the training folds, and then its performance is evaluated on the validation fold. This process is repeated k times, each time with a different fold serving as the validation set. After all iterations, the performance metrics from each fold are averaged to give a final performance estimate. This method provides an estimate of the model's ability to generalize to unseen data, as it reduces the bias associated with a single train-test split. By averaging results across multiple folds, k-fold cross-validation reduces variance and provides a more reliable measure of model performance. A common choice for k is 5 or 10, but it can vary depending on the dataset size and computational resources.

Stratified K-Fold: In cases of imbalanced datasets, a stratified version of k-fold cross-validation is used, ensuring that each fold has a similar distribution of classes. This allows recursive backtesting of previous dates by the user for any worker whether they have been previously injured or not.

Frailty Score Calculation 506 is used to generate individual specific frailty scores, industry level frailty scores, position-based analysis (e.g. the particular employee's job definition analyzed as a group. For example, in the medical field, OR doctors might have a separate frailty score than ER doctors). The Frailty Score calculation includes environmental (or game condition) factors as noted above, along with historical trend data. Depending on the job definition, the system may weight the frailty score by some factor because the job definition may be more susceptible to certain kinds of injuries than other job definitions. For example, in football, a quarterback may have a greater risk of hand injuries and a lower risk of ACL injuries compared to a running back or a wide receiver.

The system provides API and Integration 508 including RESTful Endpoints (URLs that provide access to resources or services in a REST (Representational State Transfer) API.), Authentication and Security, Data Format Standardization, and Third Party Integration. Performance Analytics 509 performs Model Accuracy Tracking, System Performance Monitoring, User Inter-‘ 5action Analysis, and Business Impact Assessment.

### Insurance Product Generation 507

The present system provides a fantasy team owner with the ability to purchase insurance on any or all team members. In one embodiment, the insurance can be purchased for an entire seasons, for a part of a season, or on a game by game basis. The premium will vary depending on the amount of time to insure the player (e.g., the length of time the player is injured), the position played, and the fantasy rating of the player. In one embodiment, other factors can be used to calculate premiums and payoffs, including historical injury information for a player and/or a position, age, weather, field type (turf, grass, indoor, outdoor, and the like) and the duration of the injury being insured. In one embodiment, the length could be season ending, 6-8 weeks, 4-6 weeks, 2-4 weeks, 1 week, or in-game for SLS. For DFS the length is in-game only in one embodiment. In one embodiment, the premiums will change depending on if the insurance is purchased before or after official team injury reports (if any) are issued. In one embodiment, the amount of the premium includes factoring in the average number of fantasy points generated by the individual player and/or the player position. In one embodiment, a player is not insurable if he is on the injury report. A player can be insured before any injury and before being placed on an injury report.

The payout for an injured player depends on the amount and time period of insurance. The payout for a star player will typically be greater than for a lesser player and may also be tied to fantasy point production. In one embodiment, the payout can be transferred directly to the team owner for any desired use.

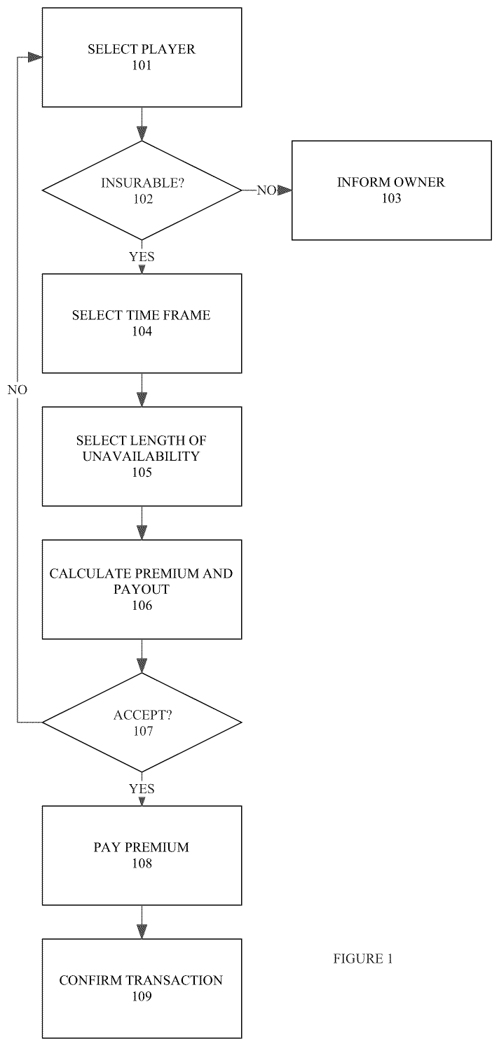

FIG. 1 is a flow diagram illustrating purchasing fantasy sports insurance in an embodiment of the system. At step 101 the team owner selects a player to insure. At decision block 102 it is determined if the player is insurable or not. If no, the system proceeds to block 103 and informs the owner that insurance is not available. This may be because the player is already injured, not on an active roster, already mentioned on an injury report, on the injured reserve list, or various other reasons.

If the player is insurable, the system proceeds to step 104 and the owner selects the time frame to be insured. This could be a game, a date range, a number of games, all or part of a season, and the like. In one embodiment, the owner can select a part of a game (e.g., first half, second half, certain quarter, innings, period, etc.).

At step 105, the owner selects the length of time of unavailability to be insured. For example, the owner might want to insure about missing a part of a game, a game, a part of a season, or the rest of the season. For a DFS, the system limits the length of time to in-game injuries.

At step 106 the system calculates the premium and payout based on the parameters selected by the owner. In addition, the premium calculation includes a number of factors including injury history of the player to be insured, the position of the player, the opponent, the location of the game, the weather, length of time since previous game, and the like. In one embodiment, the system uses artificial intelligence and machine learning to dynamically calculate the premium for each transaction. The AI can be trained based on all the transactions and payouts used by the system historically, as well as any other historical data available that is helpful in determining risk of injury.

At decision block 107 the owner is offered the premium and payout and it is determined if the owner will accept the premium. If not, the system returns to step 101. If the owner accepts the premium at step 107, the owner pays the premium at step 108. At step 109, the system confirms the transaction with a binder or whatever appropriate documentation is required per state and local law. In one embodiment, the insurance may be priced similar to life insurance, where a higher premium can obtain a higher payout. In one embodiment, the owner states a desired payout and the system calculates a premium based on that payout.

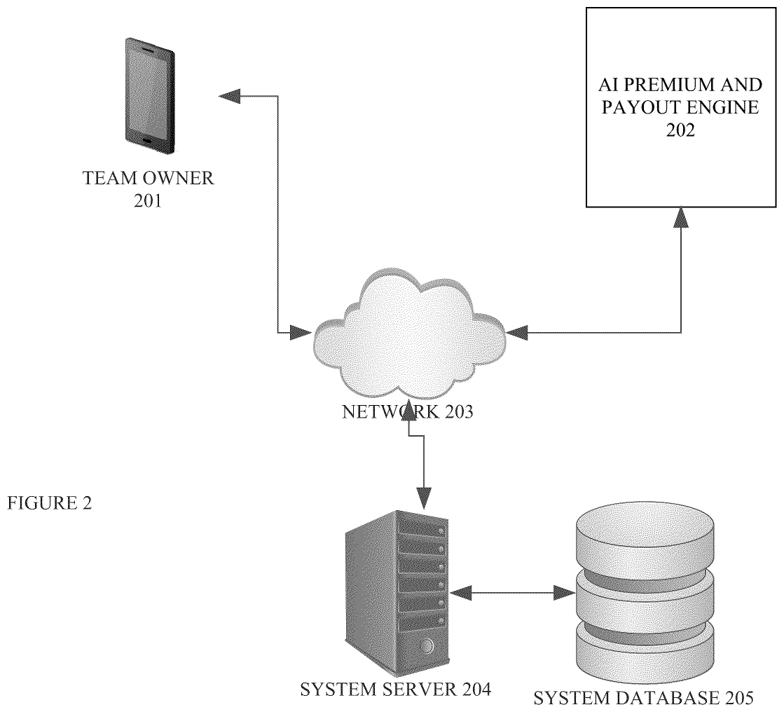

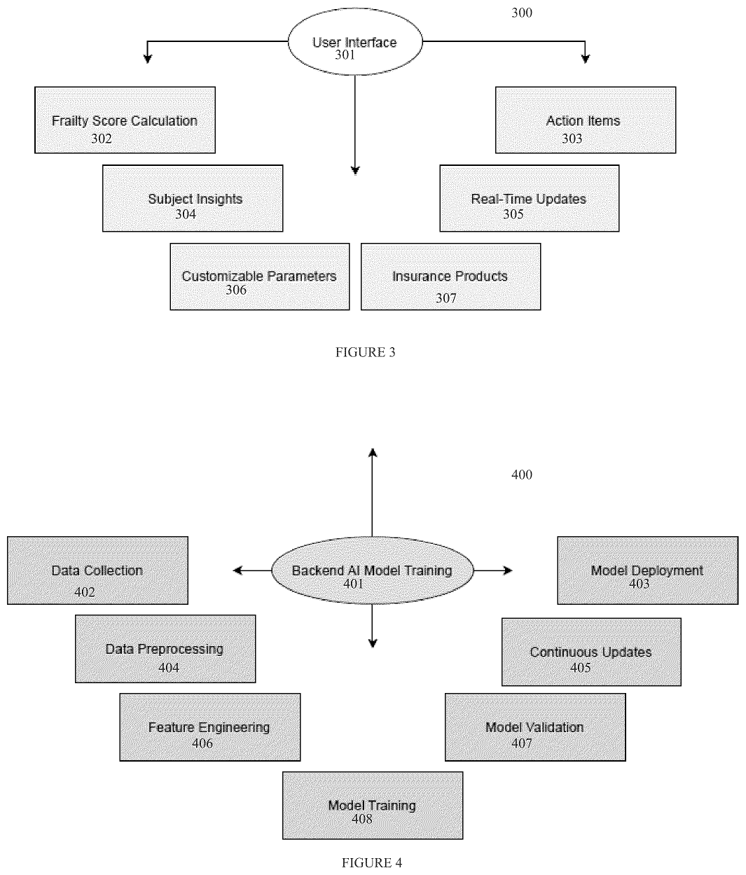

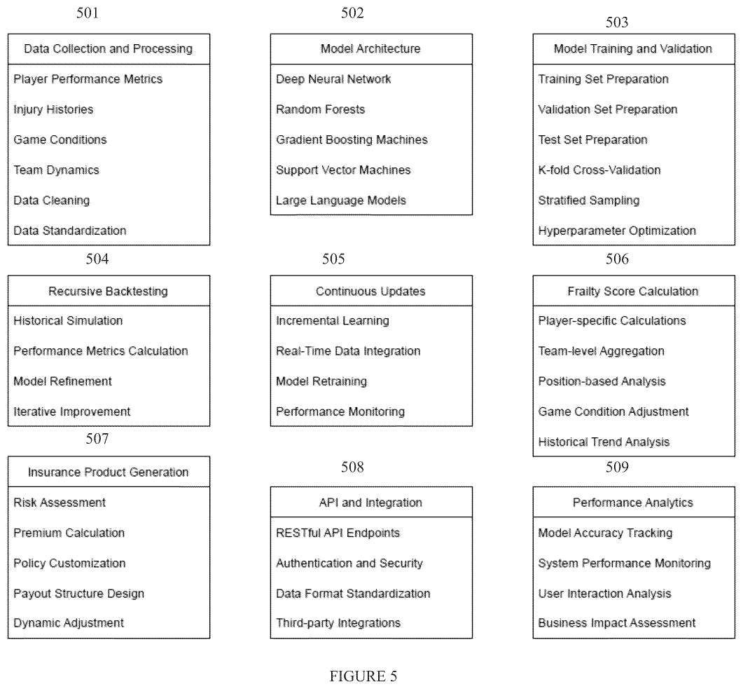

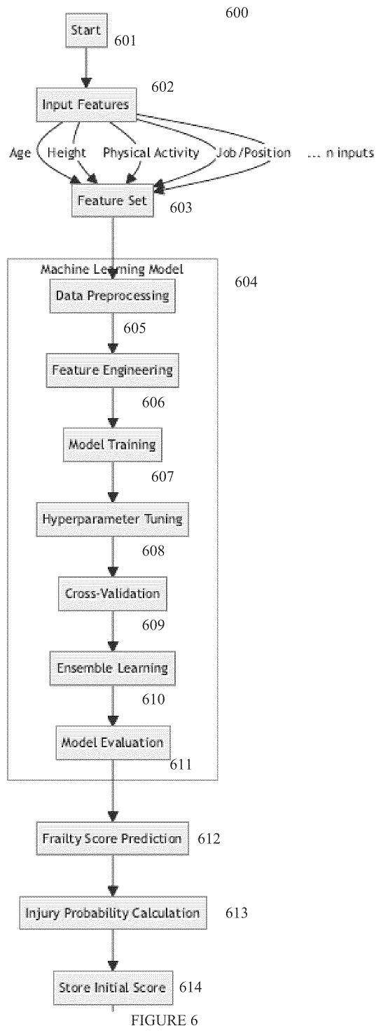

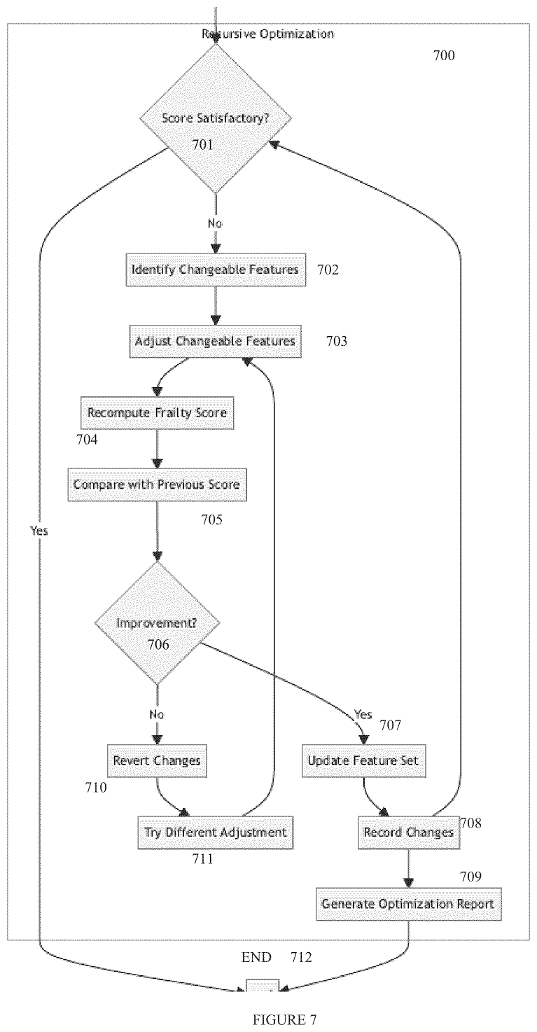

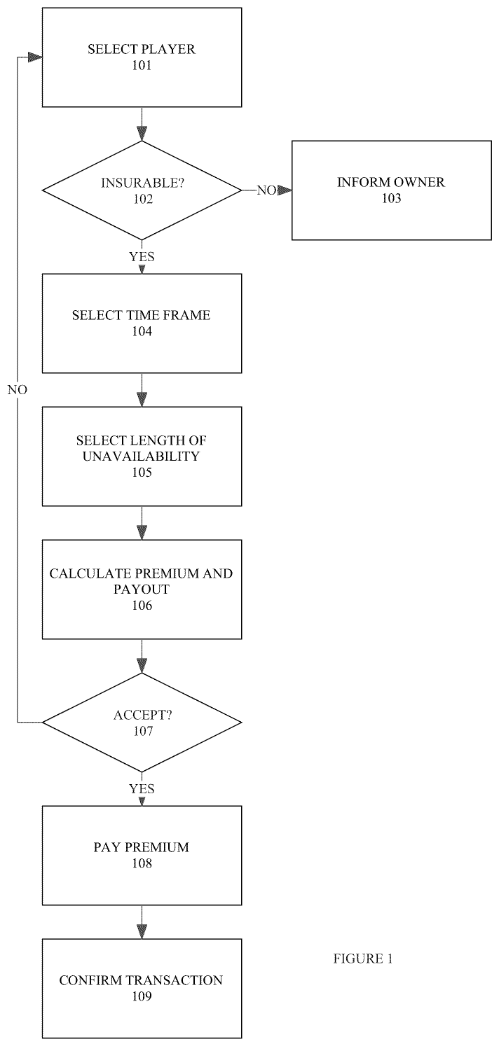

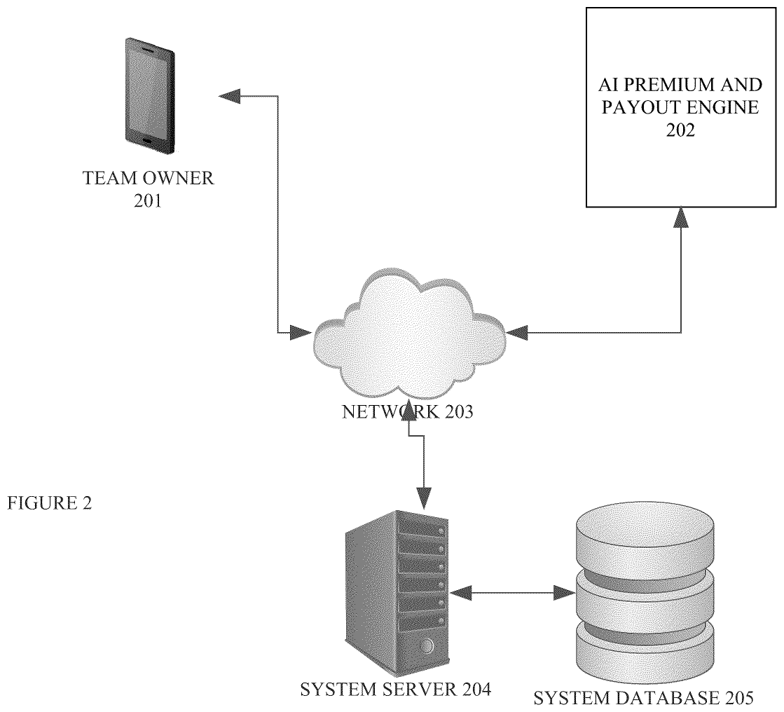

FIG. 2 is a block diagram of the system in one embodiment. The system provides an app that is accessed by a team owner on a smartphone 201 (or desktop, pad, etc.). The owner communicates to a system server 204 via network 203 (e.g., the Internet). The system server receives communications and checks player status, payment operations, and other services, using system database 205 to store relevant information.

An AI Premium and Payout engine 203 is used to calculate the premiums and payouts based on machine learning, historical data, and the like.

In one embodiment, the insurance system is integrated into the software that runs the league. For example, CBS sports provides software for SLS. DraftKings provides software for DFS. The system can be made to be part of the team management and selection process. With data offered on impact of the loss of the player, possible payouts, and cost of premiums. The team owner will be able to go through the roster and determine which players to purchase insurance for.

In another embodiment, the insurance system will be stand-alone. The team owner will select a player based on the owner's team roster, and make decisions about purchasing insurance for a player via the insurance system.

In one embodiment, the system calculates a frailty score for each player. The frailty score can be provided to an owner to aid in making insurance purchase decisions. The system itself can use the frailty score to help generate accurate premiums. The system uses advanced machine learning algorithms to accurately predict the likelihood of player injuries. The system can also be used to provide improved performance predictions for a player to determine the roster generation for an owner.

### Data Collection

The machine learning algorithm relies on multiple data points to generate the frailty score. The following is an example of the system described in connection with NFL football, but the system may be applied to any sport or fantasy activity as desired. The system will function in a similar way for all other industries, both sports related and non-sports related, with specific data and variables being different depending on the industry. In addition to the data noted above the system also includes the following data to generate the frailty score for each individual.

### Passing Stats

Passing Yards: The total number of yards gained through completed passes.
Passing Touchdowns: The number of touchdowns achieved via passes.
Passer Rating: A comprehensive measure that combines a quarterback's passing attempts, completions, yards, touchdowns, and interceptions into a single rating.
Completion Percentage: The percentage of completed passes out of the total pass attempts.
Interceptions: The number of times the quarterback's passes are caught by the opposing team.
Sacks: The number of times the quarterback is tackled behind the line of scrimmage while attempting to pass.
Pressures/Hits: The number of times the quarterback is hurried, knocked down, or hit by the defense while attempting a pass.
Passing Attempts: The total number of pass attempts made by the quarterback. Passing Completions: The total number of completed passes.
Yards Per Attempt (YPA): The average number of yards gained per pass attempt.
Yards Per Completion (YPC): The average number of yards gained per completed pass.
Touchdown to Interception Ratio (TD/INT): The ratio of passing touchdowns to interceptions.
Longest Pass (Long): The longest completed pass in terms of yards.
Completion to Attempts Ratio (Comp/Att): The ratio of completed passes to pass attempts.
Adjusted Yards Per Attempt (AY/A): Yards per attempt adjusted for touchdowns and interceptions.
Net Yards Per Attempt (NY/A): Yards per attempt adjusted for sacks.
Adjusted Net Yards Per Attempt (ANY/A): Net yards per attempt adjusted for touchdowns and interceptions.
Passes Defended (PD): The number of passes successfully defended by the quarterback's targets.
Play Action Passing Yards: Yards gained on play action passes.
Deep Ball Attempts: Number of passes attempted that travel 20 or more yards downfield.

### Rushing Stats

Rushing Yards: The total number of yards gained by the individual through rushing attempts.
Rushing Touchdowns: The number of touchdowns scored by the individual through rushing plays.
Rushing Attempts: The total number of times the individual carries the ball during rushing plays.
Fumbles: The number of times the individual loses possession of the ball during rushing attempts.
Receptions by RBs: The number of passes caught by running backs, contributing to their overall offensive output.
Yards Per Carry (YPC): The average number of yards gained per rushing attempt.
Longest Rush (Long): The longest rushing attempt in terms of yards.
Rushing First Downs: The number of first downs achieved through rushing plays.
Yards After Contact (YAC): The number of yards gained after initial contact with a defender.
Broken Tackles: The number of tackles the individual breaks or evades.
Rushing Attempts Per Game: The average number of rushing attempts per game.
Rushing Yards Per Game: The average number of rushing yards per game.
Rushing Plays of 20+Yards: The number of rushing plays that gain 20 or more yards.
Rushing Plays of 40+Yards: The number of rushing plays that gain 40 or more yards.
Red Zone Rushing Attempts: The number of rushing attempts within the opponent's 20-yard line.
Goal Line Carries: The number of rushing attempts within the opponent's 5-yard line.
Rushing Efficiency: A measure of the individual's effectiveness on rushing attempts, often combining multiple metrics.

### Receiving Stats

Receptions: The total number of passes caught by the individual.
Receiving Yards: The total number of yards gained by the individual through receptions.
Receiving Touchdowns: The number of touchdowns scored by the individual through receptions.
Targets: The total number of times the individual is targeted by the quarterback for a pass.
Drops: The number of times the individual fails to catch a pass that should have been caught.
ADOT (Average Depth of Target): The average distance downfield an individual is targeted on passes.
Routes Run: The total number of routes the individual runs during passing plays, often expressed as a percentage of the team's passing plays.
Yards After Catch (YAC): The total number of yards gained after the individual catches the ball.
Catch Rate: The percentage of targets that are caught by the individual.
Longest Reception (Long): The longest reception in terms of yards.
Receiving First Downs: The number of first downs achieved through receptions.
Yards Per Reception (YPR): The average number of yards gained per reception.
Contested Catches: The number of catches made with a defender closely contesting the catch.
Red Zone Targets: The number of times the individual is targeted within the opponent's 20-yard line.
End Zone Targets: The number of times the individual is targeted in the end zone.
Catchable Target Rate: The percentage of targets considered catchable by the individual.
Receiving Plays of 20+Yards: The number of receiving plays that gain 20 or more yards.
Receiving Plays of 40+Yards: The number of receiving plays that gain 40 or more yards. Separation: The average distance the individual creates between themselves and the defender at the time of the catch.

The system also incorporates environmental factors into the data set, including weather conditions.

### Weather Conditions

Temperature:
High temperatures: Impact on worker endurance and risk of heat-related illnesses.
Low temperatures: Risk of hypothermia and reduced worker performance.
Temperature swings: Rapid changes in temperature can affect worker conditioning.
Precipitation:
Rain: Affects stability, balance, and grip, increasing the risk of slips and falls.
Snow: Affects visibility and footing
Sleet: Mix of rain and snow, causing very slippery conditions.
Hail: Can cause injuries.
Fog: Reduces visibility, affecting both individuals and spectators.
Wind Speed:
Light wind: Minimal impact on worker.
Moderate wind: Can affect ladder work and other work activities.
Strong wind: possible dangerous conditions.
Gusts: Sudden, unpredictable changes in wind speed can create risk of falls.
Humidity:
High humidity: Increases worker fatigue and risk of dehydration.
Low humidity: Can lead to dry skin and respiratory discomfort.
Air Pressure:
High altitude: Thinner air can affect breathing.
Visibility:
Affected by fog, heavy rain, or snow.

The system also tracks other factors, such as day of week, time of day, night vs day, pre- or post holiday timing, holiday factors, previous work schedule, overtime conditions, missing co-workers, level of experience of worker as well as co-workers.

### Game Conditions

Injsur.ai considers various game conditions that influence injury probabilities.

These factors are customizable and can be included and excluded by the user in the interface.
Field Type Natural Grass:
Pros: Softer surface, potentially fewer joint injuries.
Cons: Can become muddy and slippery in poor weather conditions.
Artificial Turf:
Pros: Consistent playing surface, better drainage.
Cons: Higher risk of certain injuries like turf toe and joint strains.
Hybrid Fields: Combination of natural grass and artificial elements for durability.
Indoor Stadium:
Climate controlled: No weather impact, consistent conditions.
Different playing surface, typically artificial turf.
Outdoor Stadium:
Exposed to all weather conditions, affecting play and individual safety.
Varies in surface type (natural grass or artificial turf).

### Game Timing

Day Game:
Typically scheduled in the afternoon.
Can be impacted by high temperatures or strong sunlight.
Night Game:
Scheduled in the evening.
Cooler temperatures, potentially more dew on the field.
Travel Fatigue:
Long-distance travel: Can lead to individual fatigue, affecting performance.
Cross-time zone travel: Disrupts individual sleep cycles and recovery.
Short Week Games:
Thursday games: Less recovery time after a Sunday game, higher injury risk.
Saturday games: Disrupts typical weekly schedule, less preparation time.
Monday to following Sunday games: Slightly shorter recovery period, but generally less impactful than Thursday games.
Back-to-Back Road Games: Consecutive games played away from home, increasing travel fatigue.
Primetime Games:
Increased media attention, potentially affecting individual performance due to pressure.
Different preparation routines compared to regular game times.
Bye Week:
Week off for rest and recovery.
Potential impact on rhythm and momentum.

### Team Dynamics

Factors related to team dynamics and individual workload are also incorporated into injury risk assessments:
Individual Workload: Number of snaps, practice intensity, duration and frequency.
Team Schedule: Frequency of games and how game schedules affect injury risk.
Coaching Strategy: Offensive and defensive play style, risk management.

In addition to calculating a frailty score for each individual, the system can also provide data on how the frailty of an individual can impact the performance of other individuals (whether the other individuals have a low frailty score or not). The ability of any particular individual to generated fantasy points may be impacted by the loss of another individual due to the frailty of that other individual. For example, if a quarterback is injured, this necessitates bringing a back-up quarterback. This substitution could impact the fantasy points of a receiver who relies on the passing ability of the quarterback.

In one embodiment, the frailty score is used to dynamically adjust payouts for insured individuals. An individual with a higher frailty score, meaning that an injury is more likely, will have a lower payout than an individual with a lower frailty score. Injury policies can be customized for individual risk profiles.

In one embodiment, the user can be provided with an interface that allows the user to adjust weights for individual statistics, injury history and game conditions. The user can use the system frailty score or generate their own custom frailty score as desired.

Thus, a method and apparatus for fantasy sports insurance has been described.

What is claimed is:

1. A system for predicting a likelihood of injury of an individual, comprising:
a processor configured to execute machine learning algorithms;
a specialized dataset comprising physical, medical, or behavioral data of the individual;
an artificial intelligence (AI) engine operable to process the specialized dataset to generate a frailty score for the individual, the frailty score representing the likelihood of the individual being injured;
an action module configured to trigger one or more actions based on the frailty score, wherein the actions are aimed at reducing the likelihood of injury or advising the individual on whether to engage in potentially injury-inducing behaviors.

2. The system of claim 1 wherein the AI processes the specialized dataset using feature engineering, model training, hyperparameter tuning, cross-validation, ensemble learning, and model evaluation.

3. The system of claim 1 further including performing recursive optimization on the frailty score.

4. The system of claim 3 wherein the recursive optimization comprises identifying changeable features of a feature set, adjusting the changeable features, recomputing a frailty score and comparing it to a previously generated frailty score and determining if the recomputed frailty score is an improvement.

5. The system of claim 4 wherein the adjusting of the changeable features is saved when the frailty score is an improvement.

6. The system of claim 5 wherein the adjusting of the changeable features is reverted when the frailty score is not an improvement.

7. The system of claim 1 wherein the individual is in an industry.

8. The system of claim 7 wherein the specialized dataset comprises injury information for the industry.

9. The system of claim 8 wherein the specialized dataset further comprises environmental data including weather, time of day, day of week, and type of activity of the individual.

10. The system of claim 1 wherein the AI engine utilizes linear models, tree-based models, and neural networks.

11. A system for predicting a likelihood of injury of an athlete, comprising:
a processor configured to execute machine learning algorithms;
a specialized dataset comprising physical, medical, or behavioral data of the athlete;
an artificial intelligence (AI) engine operable to process the specialized dataset to generate a frailty score for the athlete, the frailty score representing the likelihood of the individual being injured;
an insurance module configured to define a premium for insurance for the athlete, the premium based on the frailty score.

12. The system of claim 11 wherein the insurance can be used as part of a fantasy sports league.

13. The system of claim 12 wherein the insurance premium is based on a position of the athlete.

14. The system of claim 13 wherein the insurance premium is based on the value of the athlete based on fantasy sports ratings.

15. The system of claim 11 wherein the athlete is a football player.

16. The system of claim 12 wherein the specialized dataset comprises historical injury report information regarding a plurality of football players.

17. The system of claim 16 wherein the specialized data set further comprises location of a game involving the athlete, weather conditions at game time, injury history of the athlete, presence of other athletes in the game, day of week of the game, and time of day of the game.

18. The system of claim 17 wherein the system is integrated into fantasy sports software.
